(19) United States
(12) Patent Application Publication
(10) Pub. No.: US 2005/0034522 A1
(43) Pub. Date: Feb. 17, 2005

(54) Sensor, in particular a pressure sensor with a gasket that seal it from a measuring area

(76) Inventor: Thomas Kopp, Wolfach (DE)

Correspondence Address: NATH & ASSOCIATES, 1030 15th STREET, NW, 6TH FLOOR, WASHINGTON, DC, 20005, US

(21) Appl. No.: 10/851,994

(22) Filed: May 21, 2004

(30) Foreign Application Priority Data
Jun. 2, 2003 (DE) 10324818.8

(51) Int. Cl. G01L 7/08

(52) U.S. Cl. 73/715

(57) ABSTRACT

The invention relates to a pressure sensor (2) with a sensor device (20), a casing (3), a sensor device joining fixture (22, 41, 42) for securing the sensor device (20) in the front area of the casing (3, 35), wherein the front of the sensor device (20) faces a measuring area (10), a free space (40) between a peripheral wall (40) [sic; should be (24)] of the sensor device (20) and an inside wall (32) of the casing (3) and a gasket (4) in the space (40) between the sensor device (20) and the casing (3) to form a seal relative to the measuring area (10). In order to provide a gapless sensor for use under aseptic conditions with the use of a conventional O-sealing ring as the gasket (4), the sensor (2) is designed in such a way that the space (40) tapers conically toward the front, and a clamping fixture (41, 43) is arranged behind the gasket (4), and the gasket (4) presses forward into the tapering space (40).

The invention relates to a sensor, in particular to a pressure sensor, with a gasket in the space between a sensor device and a casing to seal the space in between from a measuring area with the features in the preamble to claim 1, and to a method for assembling such a sensor.

Such a sensor is known from DE 42 34 290 A1, for example.

Generally known in the art are sensors, in particular pressure sensors, which have a casing that incorporates a sensor device to determine parameters in a measuring area. The measuring area here is typically the inside of a container, wherein the container has a conductor entry through which the sensor is routed in such a way that the front sensor device projects inside the container or comes into contact with it. In order to seal the interior of the sensor casing from a medium inside the container, a gasket is placed between a front wall of the casing and the actual sensor device. Conventional gaskets used especially in cylindrical pressure sensor elements, e.g., made of ceramic materials, here include O-rings or molding gaskets made of elastomers.

When using an O-ring seal, an elastomer, for example, is radially clamped between two parallel cylindrical surfaces, i.e., the inner wall of the sensor casing, and the lateral outer wall of the sensor device. To prevent the O-ring from being pulled away from the pressure sensor element as the sensor device for the measuring area, i.e., the container interior, under a vacuum, such a casing has a stop for the gasket. Because the stop restores the gasket relative to the front of the sensor, however, an undesired open gap forms between the outside front wall of the sensor device and the facing wall of the stop on the casing side. The gap makes it impossible to employ this sealing concept for aseptic applications, in which no germs can be allowed to deposit.

Known seals for aseptic process connections or measuring areas are realized with so-called molding gaskets. The molding gaskets are configured here in such a way that no gap forms between the sensor device and sensor casing, in which bacterial colonies can become deposited. However, one disadvantage here is that these molding gaskets extrude out of the gap and into the measuring area when there is a rise in temperature, due to temperature-induced volumetric expansion, and withdraw again in the cooling process, thereby destroying the elastomer. Another disadvantage has to do with the respective availability of certain elastomer mixtures for the gaskets. Since each elastomer mixture varies in terms of contraction, a separate tool has to be made for each new mixture with an altered contraction in order to fabricate the special molding seal or, as the case may be, given molding seals with standardized dimensions, to fabricate the sensor components.

The object of the invention is to improve the structure of a sensor in terms of the seal between the actual sensor device and the casing in the transitional region leading to the measuring area. In particular, a pressure sensor element is to be provided with a seal for aseptic purposes, which satisfies the requirement that there be no gaps. In addition, the seal is to be brought about using simple gaskets.

This object is achieved by a sensor, in particular a pressure sensor with the features in claim 1. In terms of method, such a sensor is fabricated according to the steps in claim 11.

One especially preferred pressure sensor has a casing, whose frontal section incorporates a sensor device secured therein by means of a sensor device joining fixture, wherein the front of the sensor device faces a measuring area, in particular communicates with the measuring area or process connection. A free space in which a gasket is placed to seal the sensor interior from the measuring area is formed between a peripheral wall of the sensor device and an inside casing wall of the casing. The free space tapers conically toward the front, wherein the gasket is pressed forward, i.e., toward the measuring area, into the tapering space by means of a clamping fixture situated behind the gasket. The walls of the conically tapering space hence form an abutment for the gasket, so that the gasket can only extend into the measuring area to a desired, allowable extent. As a result of this arrangement, simple means can be used to completely seal the gap, wherein damage to the gasket is prevented even when the seal expands or contracts during a measuring process or in conjunction with a measuring process. In particular, a commercially available gasket can be utilized as an O-ring seal when using a sensor having a cylindrical sensor device in such an arrangement.

The subclaims describe advantageous embodiments.

The clamping fixture advantageously has a spacing element, which is designed as a spacing ring in an especially preferred embodiment. The spacing element can be an integral part of the clamping fixture. However, the spacing element is preferably a standalone component, since such a spacing element can be adjusted with respect to the dimensioning and shaping of the free space between the lateral wall of the sensor device and inner wall of the casing, which comprise the free space. Depending on the available gasket, in particular the material, dimensions and shape of the gasket, a correspondingly suited spacing element can also be used, which is inserted between the clamping fixture and gasket. During assembly of the sensor, the clamping fixture then presses against the gasket, either itself or via the inserted spacing element, pressing the gasket into the frontal area of the space between the sensor device and the casing until there remains no gap relative to the process side, i.e., the measuring area, into which elements, in particular living cells, can become deposited.

In addition to embodiments in which both walls bounding the free space taper conically toward the front of the sensor, use can also be made of embodiments in which one of the walls, in particular the lateral peripheral wall of the sensor device, does not taper. With respect to the tapering, both straight and curved wall progressions are possible.

The transitions from the walls of the space to the corresponding front walls of the process area, i.e., the transition from the lateral wall of the sensor device to its front on the one hand, and from the inner casing wall to the front of the casing on the other, are preferably laid out in such a way that the gasket is not damaged during an expansion and contraction. As a result, the sensor can be used with a gasket that is in contact with the measuring area or process connection, even in cases where thermal variations that expand or contract the gasket and/or casing wall and sensor device are permitted during the process monitored by the sensor. Such an arrangement can also be used to offset pressure changes, i.e., a vacuum arising in the container, drawing the gasket into the measuring area further than it would project out of the free space between the walls of the sensor device and the casing under normal pressure. It is also possible to offset excess pressures, wherein the gasket projects too far into the measuring area under normal pressure, and only extends into the measuring area to the desired extent when an excess pressure is applied.

The transitions from the walls comprising the free space with gasket to the corresponding fronts advantageously have a correspondingly rounded shape. It is also advantageous for the acceptance angle of the two front walls to measure less than 180°, in particular less than 170°, proceeding from the front end of the free space. On first inspection, the angle relative to the measuring area between the section of the gasket projecting out of the space and the front wall of the sensor device or the casing advantageously exceeds 90°, in particular 100°.

In terms of the method, thus, a sensor device is advantageously arranged in the front casing section during sensor assembly in such a way that a free space that conically tapers toward the front remains between the lateral wall of the sensor device and the inside wall of the casing. A gasket is placed in this free space, and subsequently pressed or squeezed toward the process connection, i.e., toward the front measuring area, by means of a clamping fixture. The clamping fixture can advantageously be simultaneously designed to attach a sensor device, in particular a pressure sensor element, with the formation of a rear abutment.

The sensor assembled in this way is then screwed into a container hole to determine a corresponding parameter on the process side.

An exemplary embodiment shall be described in greater detail below based on the drawing.

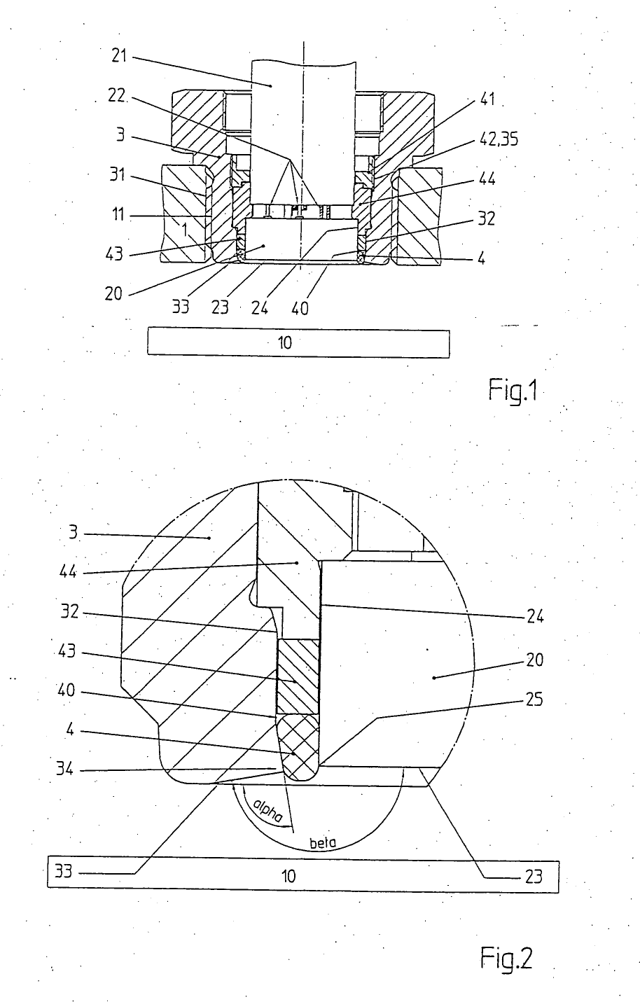

FIG. 1 shows a partial sectional view through the front section of a sensor placed in a container wall, and

FIG. 2 shows a magnified view of the transitional area from a sensor device to a casing wall with an interspersed gasket.

As evident from FIG. 1, a sensor 2 is placed in the wall of a container 1 via its casing 3. The depicted casing 3 and wall of the container 1 are joined, for example, using a threaded connection consisting of a casing thread 31 and a container thread 11, which gear into each other, as is known in the art.

The sensor 2 consists of numerous individual components, of which essentially only those components necessary for understanding the exemplary embodiment are presented below.

The front area of the casing 3 incorporates a receptacle, in which an actual sensor device 20, in particular a pressure sensor element, is placed. In the exemplary embodiment shown, the sensor device 20 is connected with sensor circuitry 21 in the back of the casing via joining fixtures 22.

The joining fixtures 22 can be mechanical joining and mounting elements, but preferably also have electrical connections for purposes of power supply and/or signal transmission, and pressure compensation lines and the like. The front 23 of the sensor device 20 communicates with the process side or measuring area 10 of the container. The terms front and rear are essentially used only to clearly describe the arrangement and alignment of individual components of the sensor 2.

A free space 40 is formed between a lateral wall, in particular peripheral wall 24 of the sensor device 20 and an opposing inside casing wall 32. One or both of these opposing walls 24, 32 of the sensor device 20 or the casing 3 are configured toward the front in such a way that the cross section tapers through the front space 40 conically toward the front.

Inserted into the front section of the free space 40 is a gasket 4, advantageously a commercially available gasket made of an elastomer, which can be a commercially available toroidal sealing ring or commercially available O-ring given a cylindrical structure of the sensor 2, or at least of the sensor device 20. The material comprising the gasket 4 can be an elastomer that resiliently offsets temperature or pressure-induced expansions to prevent stresses and resultant measured value distortions. To enable use of the sensor in aseptic applications, the gasket is pressed toward the front until no free gap remains on the side of the measuring area. In the preferred embodiment, no gap remains between either the front of the gasket 4 and the front 23 of the sensor device 20, or between the gasket 4 and the front 33 of the casing 3.

A clamping fixture that can be designed as a standalone clamping element and serves only for pre-stressing the gasket 4 is used to correctly position the gasket 4, i.e., press it forward into the free space 40 to a sufficient extent.

In the embodiment shown, the clamping fixture consists of several components, and is simultaneously used to brace additional sensor components. The clamping fixture 41 has a lateral thread 42 that engages with an internal thread 35 of the casing, so that the clamping fixture 41 can be moved to and fro relative to the inside wall of the casing 3 and clamped. At least one section of the front of the clamping fixture 41 presses against a spacing element 43, specifically against a spacing ring in the depicted cylindrical embodiment of the sensor 2. This spacing element 43 and, as the case may be, a front section of the receiving ring 44 extend into the free space 40. The front of the spacing element 43 presses against the rear of the gasket 4. By tightening the clamping fixture 41 forward relative to the casing 3, the spacing element 43 and the gasket 4 over it are hence pressed toward the front into the space 40 and, given a corresponding forward motion and clamping pressure, through the space 40, which is still partially open toward the front, into the measuring area 10. In the embodiment shown, the clamping fixture 41 is simultaneously used to form an abutment for the sensor device 20 in a backward direction. A rigid connection with the sensor device 20 is also possible, so that the clamping fixture 41 forms a component with a sensor device joining fixture. In the embodiment shown, a receiving ring 44 is accordingly situated as another element between the clamping fixture 41 designed as a set screw and the spacing element 43.

As evident from FIG. 2, the free space or transitions to the fronts 23, 33 of the sensor device 20 or casing 3 can be designed in various ways, wherein other embodiments can also be realized.

As particularly evident based on FIG. 2, the gasket 4 is pressed toward the front into the space 40 through the clamping fixture 41, the receiving ring 44, and finally the spacing element 43 until the front of the gasket 4 projects or expands slightly into the process connection or measuring area.

According to preferred embodiments, the transition from the front 23 of the sensor device 20 or front 33 of the casing 3 to the surface of the gasket 4 is selected as the radial transition.

In preferred embodiments, the acceptance or transition angle β from the front 23 of the sensor device 20 to the front 33 of the casing advantageously measures less than 180°, in particular less than 170°, so as to protect the sensor device against mechanical damage during assembly and disassembly.

During assembly, the individual elements of the sensor 2 are put together in a manner essentially known in the art. The sensor device 20 is placed in the front opening of the casing 3 in such a way as to leave a space 40 between the lateral peripheral wall 24 of the sensor device 20 and the inside casing wall 32 of the casing 3 that conically tapers toward the front or process side 10. The gasket 4 is placed in this space, and subsequently pressed forward by means of a clamping fixture until it preferably projects slightly out of the remaining gap and into the measuring area 10. In the preferred method, the gasket 4 is pressed forward by means of a spacing element 43, wherein the spacing element extends into the space 40, and is itself pressed forward with the help of the clamping fixture.

In order to accommodate the spacing element 43 and a gasket designed in particular as a conventional O-ring, the space 40 in this embodiment and method is advantageously even wider than in known arrangements. Inaccuracies in dimensioning can also be easily remedied via the correct selection of a suitable spacing element 43 and suitable gasket 4.

In the preferred embodiment shown, a circular sealing ring is hence placed into the space 40, and reshaped therein using a spacing element 43 in such a way as to fill the remaining gap or space 43 [sic; should be (40)] between the pressure sensor element as the sensor device 20 and the sensor casing 3, wherein the circular sealing ring is squeezed as a gasket 4 between the cylindrical periphery of the pressure sensor element and a conical surface 32 as the inside casing wall or standalone component on the sensor casing 3 with the attachment 41 of the sensor device. In this case, the sealing ring is placed ahead of the medium side or front of the sensor device 20 at a distance where sealing takes place within the tangential plane surface of the gasket 4.

The annular gasket can advantageously also be used for aseptic applications given high temperature differences, since the gasket 4 can outwardly expand out of the gap or space 40 without being destroyed, and then reconstitute itself.

As opposed to the arrangement known in the art, the gasket 4 need also not be retained by a shoulder in applications involving a vacuum in the process connection, since the gasket 4 is held back by the gap or space 40 between the sensor device and sensor casing that narrows toward the medium.

No client-specific tool need be procured for selecting the sealing ring material either, since it is also possible to use an inexpensive, commercially available gasket, in particular an O-ring.

Reference List

1 Container
10 Measuring area/process connection
11 Container attachment, e.g., thread
2 Sensor
20 Sensor device/pressure sensor element
21 Sensor circuitry
22 Joining fixture
23 Front of 20
24 Peripheral wall of 20
25 Transition area 23-24
3 Casing
31 Casing thread
32 Inside casing wall
33 Front of 3
34 Transition 32-33
35 Casing thread for 41, 42
4 Gasket
40 Space/gap between 24, 32, 10, 43
41 Clamping fixture
42 Thread of 41
43 Spacing element
44 Receiving ring

1. Sensor (2), in particular pressure sensor, with
a sensor device (20) for measured value acquisition,
a casing (3),
a sensor device joining fixture (22, 41, 42) for securing the sensor device (20) in the front area of the casing (3, 35),
a free space (40) between a peripheral wall (24) of the sensor device (20) and an inside wall (32) of the casing (3), and
a gasket (4) in the space (40) between the sensor device (20) and the casing (3) for sealing the space from the measuring area (10), characterized in that
the space (40) tapers conically toward the front, and
a clamping fixture (41, 43) is situated behind the gasket (4), and the gasket (4) presses forward into the tapering space (40).

2. Sensor according to claim 1, in which the clamping fixture (41, 43) has a spacing element (43), in particular a spacing ring.

3. Sensor according to claim 2, in which the clamping fixture (41) is designed to press the spacing element (43) against the gasket (4) during assembly of the sensor (2).

4. Sensor according to, claim 2, in which the shape of the clamping fixture (41) and/or the spacing element (43) follows the progression of the peripheral wall (24, 32) of the sensor device (20) and the casing wall (32) in the space (40).

5. Sensor according to, claim 1, in which at least one of the walls (24, 32) of the conically tapering space (40) tapers in such a way as to form an abutment in the front direction for the gasket (4).

6. Sensor according to, claim 1, in which the transitions of the walls (24, 32) of the space (40) to the front wall (23, 33) of the sensor device (20) or casing (3) are designed in such a way as not to destroy (damage) the gasket (4) during its expansion and/or contraction.

7. Sensor according to claim 6, in which the acceptance angle (β) is less than 180°, in particular less than 170°, between the front walls (23, 33).

8. Sensor according to, claim 1, in which the front of the gasket (4) is extended, in particular pressed, at least partially out of the space (40) into the measuring area (10).

9. Sensor according to claim 8, in which the angle (α) formed relative to the measuring area (10) between the section of the gasket (4) projecting out of the space (40) and the front wall (23, 33) of the sensor device (20) and/or the casing (3) exceeds 90°, in particular 100°.

10. Sensor according to, claim 1 in which the gasket (4) is a commercially available gasket, in particular an O-ring made of an elastomer.

11. Method for manufacturing a sensor, comprising a method in which,
a sensor device (20) is placed in the front of a casing (3), wherein a space (40) remains between the sensor device (20) and the casing (3), and
a gasket (4) is placed in the space (40) and pressed by a clamping fixture (41, 42, 43, 44) toward a front measuring area (10) until no gap remains between the gasket (4) and the sensor device (20) and between the gasket (4) and the casing (3) toward the measuring area (10).
